(19) United States
(12) Patent Application Publication
(10) Pub. No.: US 2024/0128506 A1
(43) Pub. Date: Apr. 18, 2024

(54) COMPOSITION

(71) Applicant: Mexichem Fluor S.A. de C.V., San Luis Potosi (MX)

(72) Inventors: Andrew SHARRATT, Runcorn (GB); Miodrag OLJACA, Concord, MA (US); Ira SAXENA, Runcorn (GB)

(21) Appl. No.: 17/768,791

(22) PCT Filed: Oct. 15, 2020
(86) PCT No.: PCT/GB2020/052591

§ 371 Date: Apr. 13, 2022

Related U.S. Application Data
(60) Provisional application No. 62/916,982, filed on Oct. 18, 2019.

(30) Foreign Application Priority Data
Nov. 11, 2019 (GB) 1916354.2
Mar. 17, 2020 (GB) 2003848.5
May 4, 2020 (GB) 2006531.4

(51) Int. Cl. H01M 10/0567; H01M 10/0525; H01M 10/054; H01M 10/0569

(52) U.S. Cl. CPC H01M 10/0567; H01M 10/0525; H01M 10/054; H01M 10/0569; H01M 2300/0037

(57) ABSTRACT

Use of a compound of Formula (I) in a nonaqueous battery electrolyte formulation wherein R₁ is independently selected from the group consisting of CF₃, CH₂CF₃ and CFHCF₃:R₂ is independently selected from the group consisting of H, F, CH₃, CH₂F, CH₂CF₃, CH₂OR₅ and O_{R}₅; R₃ is an alkyl group, with the formula CnH₂ₙ₊₁₋ₓFₓ; R₄ is H or F; and R₅ is an alkyl group substituted N with at least on fluorine substituent, with the proviso that when R₁ is CH₂CF₃ or CFHCF₃, R₂ is H, F or OR₅, wherein the compound C of Formula (I) is present in the electrolyte formulation in an amount of 95 wt. % or less.

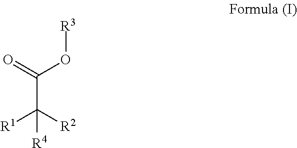

The present disclosure relates to nonaqueous electrolytic solutions for energy storage devices including batteries and capacitors, especially for secondary batteries and devices known as supercapacitors.

There are two main types of batteries; primary and secondary. Primary batteries are also known as non-rechargeable batteries. Secondary batteries are also known as rechargeable batteries. A well-known type of rechargeable battery is the lithium-ion battery. Lithium-ion batteries have a high energy density, no memory effect and low self-discharge.

Lithium-ion batteries are commonly used for portable electronics and electric vehicles. In the batteries lithium ions move from the negative electrode to the positive electrode during discharge and back when charging.

Typically, the electrolytic solutions include a nonaqueous solvent and an electrolyte salt plus additives. The electrolyte is typically a mixture of organic carbonates such as ethylene carbonate, propylene carbonate, fluoroethylene carbonate and dialkyl carbonates containing a lithium ion electrolyte salt. Many lithium salts can be used as the electrolyte salt and common examples include lithium hexafluorophosphate (LiPF₆), lithium bis (fluorosulfonyl) imide “LiFSI” and lithium bis(trifluoromethanesulfonyl)imide (LiTFSI).

The electrolytic solution has o perform a number of separate roles within the battery.

The principal role of the electrolyte is to facilitate the flow of electrical charge between the cathode and anode. This occurs by transportation of metal ions within the battery from and or to one or both of the anode and cathode, whereby chemical reduction or oxidation, electrical charge is liberated/adopted.

Thus the electrolyte needs to provide a medium which is capable of solvating and/or supporting the metal ions.

Due to the use of lithium electrolyte salts and the interchange of lithium ions with lithium metal; which is very reactive with water, as well as the sensitivity of other battery components to water; the electrolyte is usually non-aqueous.

Additionally the electrolyte has to have suitable rheological properties to permit/enhance the flow of ions therein; at the typical operating temperature to which a battery is exposed and expected to perform.

Moreover the electrolyte has to be as chemically inert as possible. This is particularly relevant, in the context of the expected lifetime of the battery, in regard to internal corrosion within the battery (e.g. of the electrodes and casing) and the issue of battery leakage. Also of importance within the consideration of chemical stability is flammability. Unfortunately typical electrolyte solvents can be a safety hazard since they often comprise a flammable material.

This can be problematic as in operation when discharging or being discharged, batteries may accumulate heat. This is especially true for high density batteries such as lithium ion batteries. It is therefore desirable that the electrolyte displays a low flammability, with other related properties such as a high flash point.

It is also desirable that the electrolyte does not present an environmental issue with regard to disposability after use or other environmental issue such as global warming potential.

It is an object of the present invention to provide a nonaqueous electrolytic solution, which provides improved properties over the nonaqueous electrolytic solution of the prior art.

### Use Aspects

According to a first aspect of the invention there is provided the use of a compound of Formula (I) in a nonaqueous battery electrolyte formulation, wherein the compound of Formula (I) is present in the electrolyte formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %. Preferably the composition comprising a compound of formula (I) is used in a lithium ion battery.

According to a second aspect of the invention there is provided the use of a nonaqueous battery electrolyte formulation comprising a compound of Formula (I) in a battery, wherein the compound of Formula (I) is present in the electrolyte formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

### Composition/Device Aspects

According to a third aspect of the invention there is provided a battery electrolyte formulation comprising a compound of Formula (I), wherein the compound of Formula (I) is present in the electrolyte formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

According to a fourth aspect of the invention there is provided a formulation comprising a metal ion and a compound of Formula (I), optionally in combination with a solvent, wherein the compound of Formula (I) is present in the formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

According to a fifth aspect of the invention there is provided a battery comprising a battery electrolyte formulation comprising a compound of Formula (I), wherein the compound of Formula (I) is present in the electrolyte formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

### Method Aspects

According to a sixth aspect of the invention there is provided a method of reducing the flammability of a battery and/or a battery electrolyte formulation, comprising the addition of a formulation comprising a compound of Formula (I), wherein the compound of Formula (I) is present in the formulation to be added in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

According to a seventh aspect of the invention there is provided a method of powering an article comprising the use of a battery comprising a battery electrolyte formulation comprising a compound of Formula (I), wherein the compound of Formula (I) is present in the electrolyte formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

According to an eighth aspect of the invention there is provided a method of retrofitting a battery electrolyte formulation comprising either (a) at least partial replacement of the battery electrolyte with a battery electrolyte formulation comprising a compound of Formula (I) and/or (b) supplementation of the battery electrolyte with a battery electrolyte formulation comprising a compound of Formula (I), wherein the compound of Formula (I) is present in the replacement electrolyte formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

According to a ninth aspect of the invention there is provided a method of preparing a battery electrolyte formulation comprising mixing a compound of Formula (I) with a lithium containing compound and a solvent, wherein the compound of Formula (I) is present in the electrolyte formulation in an amount of 95 wt. % or less. Preferably the compound of Formula (I) is present in the electrolyte formulation in an amount of 1 to 30 wt %, more preferably 5 to 20 wt %, e.g. 5 to 15 wt % or 10 wt %.

According to a tenth aspect of the invention there is provided a method of improving battery capacity/charge transfer within a battery/battery life/etc. by the provision of an electrolyte formulation comprising a compound of Formula (I).

According to an eleventh aspect of the invention there is provided a method of improving battery capacity/charge transfer within a battery/battery life/etc by the use of a compound of Formula (I).

### Electrolyte Formulation

In all aspects of the invention, the compound of Formula (I) is present in the electrolyte formulation in an amount of 95 wt. % or less, such as an amount of 75 wt. % or less, for example in an amount of 50 wt. % or less, preferably 25 wt. % or less, 20 wt. % or less, 15 wt. % or less, 10 wt. % or less, or 5 wt. % or less. More preferably, the compound of Formula (I) is present in the electrolyte formulation in an amount of from about 1 wt. % to about 30 wt. %, such as from about 1 wt. % to about 25 wt. %, such as from about 1 wt. % to about 20 wt. % or from about 5 wt. % to about 20 wt. %, for example from about 1 wt. % to about 15 wt. %, or from about 5 wt. % to about 15 wt. %, from about 1 wt. % to about 10 wt. %, or from about 1 wt. % to about 5 wt. %.

### Compound of Formula (I)

In reference to all aspects of the invention the preferred embodiment of Formula (I) is below:

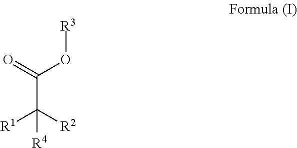

wherein
R¹ is independently selected from the group consisting of CF₃, CH₂CF₃ and CFHCF₃;
R² is independently selected from the group consisting of H, F, CH₃, CH₂F, CH₂CF₃, CH₂OR₅ and OR⁵;
R³ is an alkyl group, with the formula CₙH₂ₙ₊₁₋ₓFₓ;
R⁴ is H or F; and
R⁵ is an alkyl group substituted with at least on fluorine substituent, with the proviso that when R¹ is CH₂CF₃ or CFHCF₃, R²is H, F or OR⁵.

In reference to all aspects of the invention the most preferred embodiment of Formula (I) has the proviso that it excludes compounds of the formula below:

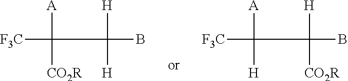

wherein A and B are independently selected from the group comprising —H, —CH₃, —F, —Cl, —CH₂F, —CF₃, —OCF₃, —OCH₂CF₃, OCH₂CF₂CHF₂ and —CH₂CF₃ (wherein both A and B cannot be H; R is an alkoxy or an alkyl group, with the formula OCₙH₂ₙ₊₁₋ₓFₓ or CₙH₂ₙ₊₁₋ₓFₓ respectively.

Alternatively and/or additionally (bearing in mind the paragraph above) a highly preferred embodiment of Formula (I) is below:

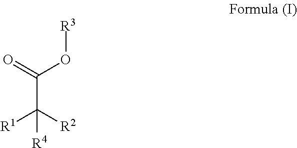

wherein
R¹ is CF₃;
R² is independently selected from the group consisting of H, F, CH₂O_{R}⁵ and OR₅;
R³ is an alkyl group, with the formula CₙH₂ₙ₊₁₋ₓFₓ;
R⁴ is H or F; and
R⁵ is an alkyl group substituted with at least on fluorine substituent.

### Advantages

In the aspects of the invention the electrolyte formulation has been found to be surprisingly advantageous.

The advantages of using compounds of Formula (I) in electrolyte solvent compositions manifest themselves in a number of ways. Their presence can reduce the flammability of the electrolyte composition (such as when for example measured by flashpoint). Their oxidative stability makes them useful for batteries required to work in harsh conditions and they are compatible with common electrode chemistries and can even enhance the performance of these electrodes through their interactions with them.

Additionally, electrolyte compositions comprising compounds of Formula (I) have been found to have superior physical properties including low viscosity and a low melting point, yet a high boiling point with the associated advantage of little or no gas generation in use, leading to reduced cell swelling. The electrolyte formulation has been found to wet and spread extremely well over surfaces particularly fluorine containing surfaces; this is postulated to result from a beneficial a relationship between its adhesive and cohesive forces, to yield a low contact angle. The electrolytes have also been found to enable low temperature performance and performance along a wider temperature range.

Furthermore, electrolyte compositions that comprise compounds of Formula (I) have been found to have superior electro-chemical properties including improved capacity retention, improved cyclability and capacity, improved compatibility with other battery components e.g. separators and current collectors and with all types of cathode and anode chemistries including systems that operate across a range of voltages and especially high voltages and which include additives such as silicon. In addition, the electrolyte formulations display good solvation of metal (e.g. lithium) salts and interaction with any electrolyte solvents present. Furthermore, they also allow for improved process chemistry and methods of manufacture, along with improved solid-electrolyte layer formation.

Preferred features relating to the aspects of the invention follows below.

### Preferred Compounds

In an embodiment of the invention, the compound of Formula (I) is a compound of Formula (II):

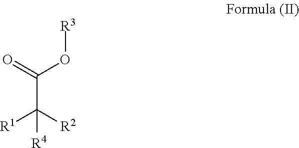

wherein
R¹ is CF₃;
R² is independently selected from the group consisting of CH₃, CH₂F CH₂CF₃ aₙd CH₂OR⁵;
R³ is an alkyl group, with the formula CₙH₂ₙ₊₁₋ₓFₓ;
R⁴ is H or F; and
R⁵ is an alkyl group substituted with at least on fluorine substituent.

In an embodiment of the invention, the compound of Formula (I) is a compound of Formula (III):

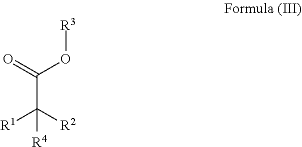

wherein
R¹ is independently selected from the group consisting of CH₂CF₃ and CFHCF₃;
R² is independently selected from the group consisting of H F and OR⁵;
R³ is an alkyl group, with the formula CₙH₂ₙ₊₁₋ₓFₓ;
R⁴ is H or F: and
R⁵ is an alkyl group substituted with at least on fluorine substituent.

In a further embodiment of the invention, the compound of Formula (I) is a compound of Formula (IV):

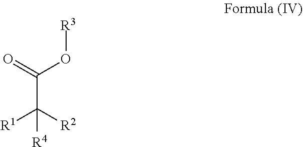

wherein
R¹ is CF₃;
R² is independently selected from the group consisting of CH₃ and CH₂F;
R³ is an alkyl group, with the formula CₙH₂ₙ₊₁₋ₓFₓ; and
R⁴ is H or F.

In an alternative embodiment of the invention, the compound of Formula (I) is a compound of Formula (V):

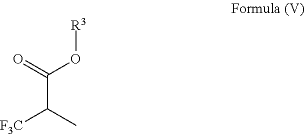

wherein R³ is an alkyl group, with the formula CₙH₂ₙ₊₁₋ₓFₓ.

In an alternative embodiment of the invention, the compound of Formula (I) a compound of Formula (VI):

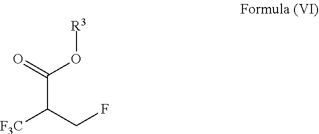

R³ is an alkyl group, with the formula CₙH₂ₙ₊₁₋ₓFₓ.

In an alternative embodiment of the invention, the compound of Formula (I) is a compound of Formula (VII):

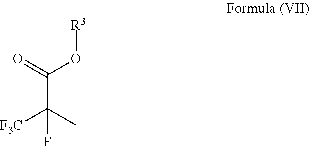

Wherein R³ is an alkyl group, with the formula CₙH₂ₙ₊₁₋ₓFₓ.

In an alternative embodiment of the invention, the compound of Formula (I) is a compound of Formula (VIII):

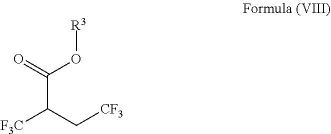

wherein R³ is an alkyl group, with the formula CₙH₂ₙ₊₁₋ₓFₓ.

In an alternative embodiment of the invention, the compound of Formula (I) a compound of Formula (IX):

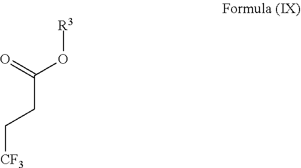

wherein R³ is an alkyl group, with the formula CₙH₂ₙ₊₁₋ₓFₓ.

In an alternative embodiment of the invention, the compound of Formula (I) is a compound of Formula (X):

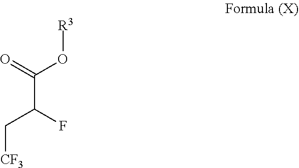

wherein R³ is an alkyl group, with the formula CₙH₂ₙ₊₁₋ₓFₓ,

In an alternative embodiment of the invention, the compound of Formula (I) is a compound of Formula (XI):

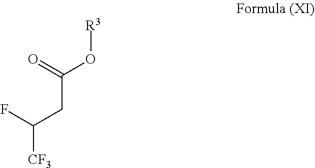

wherein R³ is an alkyl group, with the formula CₙH₂ₙ₊₁₋ₓFₓ.

In an alternative embodiment of the invention, the compound of Formula (I) is a compound of Formula (XII):

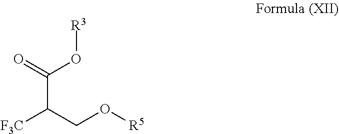

wherein R³ is an alkyl group, with the formula CₙH₂ₙ₊₁₋ₓFₓ; and R⁵ is an alkyl group substituted with at least on fluorine substituent.

In an alternative embodiment of the invention, the compound of Formula (I) is a compound of Formula (XIII):

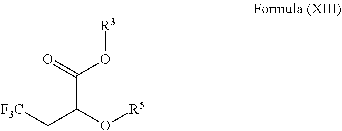

wherein R³ is an alkyl group, with the formula CₙH₂ₙ₊₁₋ₓFₓ; and R⁵ is an alkyl group substituted with at least on fluorine substituent.

In an embodiment of the invention, the compound of Formula (I) comprises at east two different compounds of Formula (I).

R³ is an alkyl group, with the formula CₙH₂ₙ₊₁₋ₓFₓ.

Preferably n is from 1 to about 10, more preferably n is from 1 to about 7, more preferably n is from 1 to about 5, most preferably n is from 1 to about 3.

Preferably x has a value from 0 to 2n+1. For the most preferred values of n, x is preferably 0, 3 or 4.

Most preferably R³ is CH₃, CH₂CH₃, CF₃, CH₂CF₃, CH₂CF₂CHF₂, CH₂CH₂CH₃, or CH(CH₃)₂.

Advantageously, R⁵ is a C₁-C₆ alkyl group substituted with at least on fluorine substituent, such as a C₁-C₅ alkyl group, C₁-C₄ alkyl group, C₁-C₃ alkyl group, or C₁-C₂ alkyl group substituted with at least one fluorine substituent. Preferably, R⁵ is a C₂ alkyl group substituted with at least one fluorine substituent.

Conveniently, R⁵ is an alkyl group as described in an of the embodiments above that is terminated with a CF₃ substituent. For example, R⁵ may be a C₁-C₆, C₁-C₅, alkyl group, a C₁-C₄ alkyl group, a C₁-C₃ alkyl group, or a C₁-C₂ alkyl group that is terminated by a CF₃ substituent. In some embodiments, R⁵ may be CH₂CH₂CF₃

Preferably, R⁵ is CH₂CF₃.

In alternative embodiments, R₅ is an alkyl group as described in an of the embodiments above that is terminated with a CHF₂ substituent. For example, R⁵ may be a C₁-C₆, a C₁-C₅ alkyl group, a C₁-C₄ alkyl group, a C₁-C₃ alkyl group, or a C₁-C₂ alkyl group that is terminated by a CHF₂ substituent. For example, R⁵ may be CH₂CH₂CHF₂ or CH₂(CF₂)CHF₂, wherein n is an integer between 1 and 5.

For the avoidance of doubt, it is to be understood that where a compound may exist as one of two configurational isomers, without any further designation, it is envisaged that either isomer or a mixture of isomers is contemplated.

Preferably, the compounds of Formula (I) have a melting point of from about −20° C. to about −76° C., such as from about −25° C. to about −60° C., preferably from about −30° C. to about −50° C.

Preferably, the compounds of Formula (I) will have a viscosity appropriate for use with heat transfer fluids, such as in refrigeration or air-conditioning devices. Conveniently, compounds of Formula (I) with have a viscosity of from about 20 to about 70 cSt, such as from 25 to about 65 cSt, from about 30 to about 60 cSt or from about 35 to about 55 cSt. Preferably, the compounds of Formula (I) will have a viscosity of from about 40 to about 50 cSt.

### Metal Salts

The nonaqueous electrolytic solution further comprises a metal electrolyte salt, present in an amount of 0.1 to 20 wt,% relative to the total mass of the nonaqueous electrolyte formulation.

The metal salt generally comprises a salt of lithium, sodium, magnesium, calcium, lead, zinc or nickel.

Most preferably the metal salt is a salt of lithium, such as those selected from the group comprising lithium hexafluorophosphate (LiPF₈), lithium perchlorate (LiClO₄), lithium tetrafluoroborate (LiBF₄), lithium triflate (LiSO₃CF₃), lithium bis(fluorosulfonyl)imide (Li(FSO₂)₂N) and lithium bis(trifluoromethanesulfonyl)imide (Li(CF₃SO₂)₂N).

Most preferably the metal salt comprises LiPF₆. Thus in a most preferred variant of the fourth aspect of the invention there is provided a formulation comprising LiPF₆ and a compound of Formula (I), optionally in combination with a solvent

### Other Solvents

The nonaqueous electrolytic solution may comprise a solvent. Preferred examples of solvents include fluoroethylene carbonate (FEC) and/or propylene carbonate (PC), dimethyl carbonate (DMC), ethylmethyl carbonate (EMC) or ethylene carbonate (EC).

Where present the additional solvent makes up from 0.1 wt % to 99.9 wt % of the liquid component of the electrolyte.

### Additives

The nonaqueous electrolytic solution may include an additive.

Suitable additives may serve as surface film-forming agents, which form an ion permeable film on the surface of the positive electrode or the negative electrode. This can pre-empt a decomposition reaction of the nonaqueous solvent and the electrolyte salt occurring on the surface of the electrodes, thereby preventing the decomposition reaction of the nonaqueous electrolytic solution on the surface of the electrodes.

Examples of film-forming agent additives include vinylene carbonate (VC), ethylene sulfite (ES), lithium bis(oxalato)borate (LiBOB), cyclohexylbenzene (CHB) and ortho-terphenyl (OTP). The additives may be used singly, or two or more may be used in combination.

When present the additive is present in an amount of 0.1 to 3 wt % relative to the total mass of the nonaqueous electrolyte formulation.

### Battery

### Primary/Secondary Battery

The battery may comprise a primary (non-rechargeable) or a secondary battery (rechargeable). Most preferably the battery comprises a secondary battery.

A battery comprising the nonaqueous electrolytic solutions will generally comprise several elements. Elements making up the preferred nonaqueous electrolyte secondary battery cell are described below. It is appreciated that other battery elements may be present (such as a temperature sensor); the list of battery components below is not intended to be exhaustive.

### Electrodes

The battery generally comprises a positive and negative electrode. Usually the electrodes are porous and permit metal ions (lithium ions) to move in and out of their structures with a process called insertion (intercalation) or extraction (deintercalation).

For rechargeable batteries (secondary batteries), the term cathode designates the electrode where reduction is taking place during the discharge cycle. For lithium-ion cells the positive electrode (“cathode”) is the lithium-based one.

### Positive Electrode (Cathode)

The positive electrode is generally composed of a positive electrode current collector such as a metal foil, optionally with a positive electrode active material layer disposed on the positive electrode current collector.

The positive electrode current collector may be a foil of a metal that is stable at a range of potentials applied to the positive electrode, or a film having a skin layer of a metal that is stable at a range of potentials applied to the positive electrode. Aluminium (Al) is desirable as the metal that is stable at a range of potentials applied to the positive electrode.

The positive electrode active material layer generally includes a positive electrode active material and other components such as a conductive agent and a binder. This is generally obtained by mixing the components in a solvent, applying the mixture onto the positive electrode current collector, followed by drying and rolling.

The positive electrode active material may be a lithium (Li) containing transition metal oxide. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

Some of the transition metal atoms in the transition metal oxide may be replaced by atoms of a non-transition metal element. The non-transition element may be selected from the group consisting of magnesium (Mg), aluminium (Al), lead (Pb), antimony (Sb) and boron (B). Of these non-transition metal elements, magnesium and aluminium are the most preferred.

Preferred examples of positive electrode active materials include lithium-containing transition metal oxides such as LiCoO₂, LiNiO₂, LiMn2O₄, LiMnO₂, LiNi_{1-y}Co_{y}O₂ (0<y<1), LiNi_{1-y-z}Co_{y}Mn_{z}O₂ (0<y+z<1) and LiNi_{1-y-z}Co_{y}Al_{z}O₂ (0<y+z<1). LiNi_{1-y-z}Co_{y}Mn_{z}O₂ (0<y+z<0.5) and LiNi_{1-y-z}Co_{y}Al_{z}O₂ (0<y+z<0.5) containing nickel in a proportion of not less than 50 mol % relative to all the transition metals are desirable from the perspective of cost and specific capacity. These positive electrode active materials contain a large amount of alkali components and thus accelerate the decomposition of nonaqueous electrolytic solutions to cause a decrease in durability. However, the nonaqueous electrolytic solution of the present disclosure is resistant to decomposition even when used in combination with these positive electrode active materials.

The positive electrode active material may be a lithium (Li) containing transition metal fluoride. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

Some of the transition metal atoms in the transition metal fluoride may be replaced by atoms of a non-transition metal element. The non-transition element may be selected from the group consisting of magnesium (Mg), aluminium (Al), lead (Pb), antimony (Sb) and boron (B). Of these non-transition metal elements, magnesium and aluminium are the most preferred.

A conductive agent may be used to increase the electron conductivity of the positive electrode active material layer. Preferred examples of the conductive agents include conductive carbon materials, metal powders and organic materials. Specific examples include carbon materials as acetylene black, ketjen black and graphite, metal powders as aluminium powder, and organic materials as phenylene derivatives.

A binder may be used to ensure good contact between the positive electrode active material and the conductive agent, to increase the adhesion of the components such as the positive electrode active material with respect to the surface of the positive electrode current collector. Preferred examples of the binders include fluoropolymers and rubber polymers, such as polytetrafluoroethylene (PTFE), polyvinylidene fluoride (PVdF) ethylene-propylene-isoprene copolymer and ethylene-propylene-butadiene copolymer. The binder may be used in combination with a thickener such as carboxymethylcellulose (CMC) or polyethylene oxide (PEO).

### Negative Electrode (Anode)

The negative electrode is generally composed of a negative electrode current collector such as a metal foil, optionally with a negative electrode active material layer disposed on the negative electrode current collector.

The negative electrode current collector may be a foil of a metal. Copper (lithium free) is suitable as the metal. Copper is easily processed at low cost and has good electron conductivity.

Generally, the negative electrode comprises carbon, such as graphite or graphene

Silicon based materials can also be used for the negative electrode. A preferred form of silicon is in the form of nano-wires, which are preferably present on a support material. The support material may comprise a metal (such as steel) or a non-metal such as carbon.

The negative electrode may include an active material layer. Where present the active material layer includes a negative electrode active material and other components such as a binder. This is generally obtained by mixing the components in a solvent, applying the mixture onto the positive electrode current collector, followed by drying and rolling.

Negative electrode active materials are not particularly limited, provided the materials can store and release lithium ions. Examples of suitable negative electrode active materials include carbon materials, metals, alloys, metal oxides, metal nitrides, and lithium-intercalated carbon and silicon. Examples of carbon materials include natural I artificial graphite, and pitch-based carbon fibres. Preferred examples of metals include lithium (Li), silicon (Si), tin (Sn), germanium (Ge), indium (In), gallium (Ga), lithium alloys, silicon alloys and tin alloys. Examples of lithium based materials include lithium titanate (Li₂TiO₃)

As with the positive electrode, the binder may be a fluoropolymer or a rubber polymer and is desirably a rubbery polymer, such as styrene-butadiene copolymer (SBR). The binder may be used in combination with a thickener.

### Separator

A separator is preferably present between the positive electrode and the negative electrode. The separator has insulating properties. The separator may comprise a porous film having ion permeability. Examples of porous films include microporous thin films, woven fabrics and nonwoven fabrics. Suitable materials for the separators are polyolefins, such as polyethylene and polypropylene.

### Case

The batterycomponents are preferably disposed within a protective case.

The case may comprise any suitable material which is resilient to provide support to the battery and an electrical contact to the device being powered.

In one embodiment the case comprises a metal material, preferably in sheet form, moulded into a battery shape. The metal material preferably comprises a number of portions adaptable be fitted together (e.g. by push-fitting) in the assembly of the battery. Preferably the case comprises an iron/steel-based material.

In another embodiment the case comprises a plastics material, moulded into a battery shape. The plastics material preferably comprises a number of portions adaptable be joined together (e.g. by push-fitting/adhesion) in the assembly of the battery. Preferably the case comprises a polymer such as polystyrene, polyethylene, polyvinyl chloride, polyvinylidene chloride, or polymonochlorofluoroethylene. The case may also comprise other additives for the plastics material, such as fillers or plasticisers. In this embodiment wherein the case for the battery predominantly comprises a plastics material a portion of the casing may additionally comprise a conductive/metallic material to establish electrical contact with the device being powered by the battery.

### Arrangement

The positive electrode and negative electrode may be wound or stacked together through a separator. Together with the nonaqueous electrolytic solution they are accommodated in the exterior case. The positive and negative electrodes are electrically connected to the exterior case in separate portions thereof.

### Module/Pack

A number/plurality of battery cells may be made up into a battery module. In a battery module the battery cells may be organised in series and/or parallel. Typically these are encased in a mechanical structure.

A battery pack may be assembled by connecting multiple modules together in series or parallel. Typically battery packs include further features such as sensors and controllers including battery management systems and thermal management systems. The battery pack generally includes an encasing housing structure to make up the final battery pack product.

### End Uses

The battery of the invention, in the form an individual battery/cell, module and/or pack (and the electrolyte formulations therefor) are intended to be used in one or more of a variety of end products.

Preferred examples of end products include portable electronic devices, such as GPS navigation devices, cameras, laptops, tablets and mobile phones. Other preferred examples of end products include vehicular devices (as provision of power for the propulsion system and/or for any electrical system or devices present therein) such as electrical bicycles and motorbikes as well as automotive applications (including hybrid and purely electric vehicles).

The invention will now be illustrated with reference to the following non-limiting examples.

### EXAMPLES

### Example 1A

### Esterification of HFO With Alcohol Using bis(triphenylphoshine)palladium (II) Chloride Catalyst

The following steps were followed.
The reactor was charged with catalyst (bis(triphenylphoshine)palladium (II) chloride), solvent and alcohol, inside a nitrogen purged glovebox. Then sealed and removed from the glovebox.
The HFO substrate was then added from a pre-loaded and weighed sample bomb.
The reactor was then pressurised with CO to c.a. 37 barg and the reactor contents heated to the desired reaction temperature with stirring.
At the end of the experiment the reactor contents were cooled, and any residual pressure vented before the crude product was recovered.
The recovered crude product was analysed by GC-MS and NMR spectroscopy.

| Expt. | EM1** | EM2 | EM8 | EM5 | EM3 | EM7 | EM4 |
|---|---|---|---|---|---|---|---|
| HFO (g) | 1243zf | 1234ze-E | 1234ze-E | 1234ze-E | 1234ze-Z | 1336mzz-E | 1336mzz-Z |
| | 9 | 7.4 | 10.8 | 3 | 10.1 | 5.5 | 5 |
| Catalyst (g) | 0.38 | 0.31 | 0.3 | 0.13 | 0.33 | 0.31 | 0.31 |
| Solvent (g) | ACN 20.41 | ACN 22.4 | ACN 29.16 | ACN 15.74 | ACN 23.05 | ACN 28.86 | ACN 22.85 |
| Alcohol (g) | EtOH 6.73 | EtOH 7.06 | EtOH 8.91 | EtOH 4.5 | EtOH 8.15 | EtOH 9.76 | EtOH 8.9 |
| Temperature (° C.) | 100 | 100 | 100 | 100 | 110 | 100 | 100 |
| Pressure (barg) | 47.8 | 46.4 | 46.4 | 49.4 | 45 | 47 | 46.2 |
| Pressure drop (barg) | 29.2 | 4.8 | 7 | 1.6 | 4.4 | 2 | 5.8 |
| Duration (hrs) | 50 | 71 | 70.5 | 73 | 50 | 47 | 71 |
| Ester yield (%) | ND | ND | 33.7 | 36.8 | 51.6 | 41.3 | 100 |

| | | | |
|---|---|---|---|
| Regioselectivity n-:iso- | 1:0.7 | 100% n-isomer | Only 1 isomer possible |

**comparative example.

| Expt. | EM6 | EM9 | EM10 | EM11 | EM12 | EM13 | EM14 | EM15 |
|---|---|---|---|---|---|---|---|---|
| HFO (g) | 1234yf | 1234yf | 1234yf | 1234yf | 1234yf | 1234yf | 1234yf | 1233xf |
| | 5.2 | 10.6 | 8.8 | 10.1 | 10.5 | 11.2 | 10.7 | 9.0 |
| Catalyst (g) | 0.3 | 0.6 | 0.27 | 0.58 | 0.62 | 0.6 | 0.6 | 0.58 |
| Solvent (g) | ACN 25 | ACN 29.71 | ACN 28.77 | ACN 28.8 | ACN 28.6 | Toluene 29.7 | THF 29.1 | ACN 29.7 |
| Alcohol (g) | EtOH 10.71 | EtOH 9.66 | EtOH 8.9 | EtOH 9.3 | MeOH 10.5 | EtOH 9.3 | EtOH 9.3 | EtOH 9.4 |
| Temperature (° C.) | 100 | 100 | 120 | 120 | 120 | 120 | 120 | 120 |
| Pressure (barg) | 44.4 | 48.4 | 51.2 | 52.6 | 49.2 | 55.2 | 50 | 51 |
| Pressure drop (barg) | 5.6 | 17.2 | 13.6 | 23 | 9 | 31.8 | 26 | 3.5 |
| Duration (hrs) | 66 | 72 | 70 | 92 | 46 | 48 | 73 | 71 |
| Ester yield (%) | 100 | 72.4 | 73.2 | 91.7 | 48.9 | 56.2 | ND | 26.3 |

| | | |
|---|---|---|
| Regioselectivity n-:iso- | 1:100 | 1:10.8 |

### Example 1B

### Esterification of 1234yf with Ethanol in Acetonitrile Using bis(di-(tert butyl)(4-trifluoromethyl)phenyl(phosphine) palladium (II) chloride or bis(dicyclohexyl)(4-dimethylaminophenylphosphine) palladium (II) chloride catalyst

The same basic procedure as example 1A was used. The catalyst a selected from bis(di-(tert butyl)(4-trifluoromethyl)phenyl(phosphine) palladium (H) chloride (A) or bis(dicyclohexyl)(4-dimethylaminophenylphosphine) palladium (II) chloride (B).

| | | | | | | Pressure | | |
|---|---|---|---|---|---|---|---|---|
| Catalyst | 1234yf | Ethanol | Time | Temperature | CO | drop | Yield | |
| (g) | (g) | (g) | (hrs) | (° C.) | (Barg) | (Barg) | (%) | n:i |
| A (0.50) | 10.5 | 9.35 | 66 | 120 | 47.5 | 28.5 | 99.4 | 1:1.49 |
| B (0.52) | 11.2 | 9.49 | 46 | 120 | 54 | 8 | 33.5 | 1:5.8 |

### Example 2

### Esterification of NFO With Alcohol

The same basic procedure as example 1A was used. The experiments were repeated in a larger scale reactor (450 ml).

| Expt. | Parr1 ** | Parr2 | Parr3 | Parr4 |
|---|---|---|---|---|
| HFO (g) | 1243ze-E | E-1234ze-E | 1234yf | 1234yf |
| | 39.2 | 36.9 | 35.1 | 36 |
| Catalyst (g) | A 1.27 | B 1.3 | B 1.26 | B 1.2 |
| Solvent (g) | ACN 133.1 | ACN 131.1 | ACN 127.66 | ACN 137 |
| Alcohol (g) | EtOH 34.5 | EtOH 34.3 | EtOH 37.86 | EtOH 35 |
| Temperature | 100 | 100 | 100 | 100 |
| (° C.) | | | | |
| Pressure (barg) | 78 | 80 | 79 | 102* |
| Pressure drop | 6 | 6 | 11 | 20 |
| (barg) | | | | |
| Duration (hrs) | 72 | 72 | 69 | 72 |
| Ester yield (%) | 24.6 | 25.0 | 89.6 | 94.4 |

*80 bar CO and 22 bar nitrogen.
** comparative example.

### Example 3

### Esterification of 1243zf With Diol

The following steps were followed.
The reactor was charged with catalyst (bis(triphenylphoshine)palladium (II) chloride (2.26 g)), solvent (acetonitrile, 133 g) and alcohol (2,2-dimethyl propane diol, 36.4 g), inside a nitrogen purged glovebox. Then sealed and removed from the glovebox.
The reactor contents were stirred.
The HFO substrate (1243zf, 39 g) was then added from a pre-loaded and weighed sample bomb.
The reactor was then pressurised with CO to c.a. 110 barg and the reactor contents heated to the desired reaction temperature (120° C.) with stirring.
After 22 hours the pressure had dropped to 62 barg.
The reactor contents were cooled and any residual pressure vented.
A second portion of HFO substrate (1243zf, 43g) was then added from a pre-loaded and weighed sample bomb.
The reactor was then pressurised with CO to c.a. 108 barg and the reactor contents heated to the desired reaction temperature (120° C.) with stirring.
After 72 hours the pressure had dropped to 80 barg.

At the end of the experiment the reactor contents were cooled, and any residual pressure vented before the crude product was recovered.

The recovered crude product was analysed by GC-MS and NMR spectroscopy.GC-MS analysis of the crude reaction mixture showed that the reaction mixture comprised all 5 possible ester products:

| Product | GC-MS Area % |
|---|---|
| 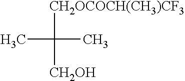 | 12.6 |
| 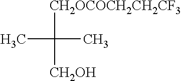 | 7.2 |
| 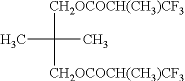 | 20.4 |
| 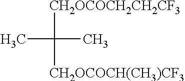 | 40.6 |
| 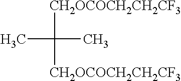 | 19.2 |

¹⁹F NMR (56 MHz) analysis of the crude reaction mixture confirmed the presence of:
Iso-ester functions (R-OCOCH(CH₃)CF₃) δ −70.95 ppm (vs C₆F₆, doublet, J=8.7 Hz)
n-esters functions (ROCOCH₂CH₂CF₃) δ −68.14 ppm (vs C₆F₆, triplet, J=10.6 Hz)

### Example 4

### Esterification of 1234yf With Diol

The following steps were followed.
The reactor was charged with catalyst (bis(triphenylphoshine)palladium (H) chloride (2.22 g)), solvent (acetonitrile, 131.7 g) and alcohol (2,2-dimethyl propane diol, 34.9 g), inside a nitrogen purged glovebox. Then sealed and removed from the glovebox.
The reactor contents were stirred.
The HFO substrate (1234yf, 104 g) was then added from a pre-loaded and weighed sample bomb.
The reactor was then pressurised with CO to c.a. 107 barg and the reactor contents heated to the desired reaction temperature (120° C.) with stirring.
After 66 hours the pressure had dropped to 57 barg.
At the end of the experiment the reactor contents were cooled, and any residual pressure vented before the crude product was recovered.
The recovered crude product was analysed by GC-MS and NMR spectroscopy.

GC-MS analysis of the crude reaction mixture showed that the reaction mixture comprised all 5 possible ester products:

| Product | GC-MS Area % |
|---|---|
| 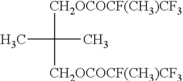 | 63.7 |
| 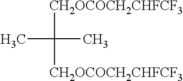 | 2.0 |
| 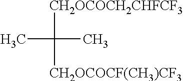 | 29.4 |
| 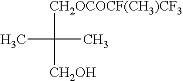 | 1.6 |
| 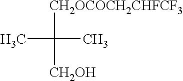 | 3.3 |

¹⁹F NMR (56 MHz) analysis of the crude reaction mixture confirmed the presence of:
Iso-ester functions (R—OCOCF(CH₃)CF₃) δ (vs C₆F₆): CF₃−80.6ppm, CF −169 (multiplet)

n-esters functions (ROCOCH₂CHFCF₃) δ (vs CsF₆): CF₃−80.6ppm, CHF −201 (multiplet)

### Example 5

### Esterification of 1234yf With Triol

The following steps were followed.
The reactor was charged with catalyst bis(triphenylphoshine)palladium (H) chloride (1.91 g)), solvent (acetonitrile, 130.54 g) and alcohol (1,1,1-Tris(hydroxylmethyl)propane, 29.44 g), inside a nitrogen purged glovebox. Then sealed and removed from the glovebox.
The reactor contents were stirred.
The HFO substrate (1234yf, 92 g) was then added from a pre-loaded and weighed sample bomb.
The reactor was then pressurised with CO to c.a. 107 barg and the reactor contents heated to the desired reaction temperature (120° C.) with stirring.
As the pressure dropped in the reactor it was re-pressurised to 107 barg with CO twice
After 79 hours the final pressure was 68 barg.

At the end of the experiment the reactor contents were cooled, and any residual pressure vented before the crude product was recovered. The recovered crude product was analysed by GC-MS.

A complex mixture of esters was produced, and the yield of these esters was estimated to be 104 g.

### Example 6

### Esterification of a Propenyl Ether

The following steps were followed:
The reactor was charged with catalyst (bis(di(tert butyl)(4 trifluoromethyl)phenyl(phosphine) palladium chloride (0.37)), solvent (acetonitrile, 29.1 g) and alcohol (ethanol, 10.16 g) and the propenyl ether (3,3,3-trifluoro-1(2,2,2-trifluoroethoxy)prop-1-ene (13.3 g), inside a nitrogen purged glovebox. Then sealed and removed from the glovebox.
The reactor contents were stirred.
The reactor was then pressurised with CO to c.a. 107 barg and the reactor contents heated to the desired reaction temperature (120° C.) with stirring (300 rpm).
After 90 hours the pressure had dropped by 7.2 barg.
At the end of the experiment the reactor contents were cooled, and any residual pressure vented before the crude product was recovered.

The recovered reaction mixture was analysed by ¹⁹F NMR, which showed signals at −60.93 and p31 64.96 ppm corresponding to the CF₃ (highlighted and underlined) groups in the acyl fragments of the products. These signals were in a ratio of 1:1 with the overlapping signals centred on −75.74 of the CF₃ groups in the ether functional group OCH₂CF₃ of both of the isomeric products:

Products

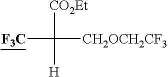

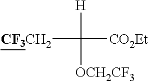

Analysis of the crude reaction mixture by GC-MS showed that (excluding solvent and excess ethanol) the crude product comprised a mixture of these esters (84.7%) and unconverted feedstock (11.4%),

### Flammability and Safety Testing

### Flash Point

Flashpoints were determined using a Miniflash FLP/H device from Grabner Instruments following the ASTM D6450 standard method:

| | Concentration (% wt) in standard electrolyte 1M LiPF₆ in (30% | | | | | |
|---|---|---|---|---|---|---|
| | Ethylene carbonate & 70% ethyl methyl carbonate) | | | | | |
| | 0 | 2 | 5 | 10 | 30 | 100 |
| Component | Flashpoint (º C.) | | | | | |
| 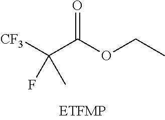 | 32 ± 2 | 38 ± 1 | 35 ± 1 | 35 ± 1 | 34 ± 1 | Not Detected |

### Self-Extinguishing Time

Self-extinguishing time was measured with a custom-built device that contained an automatically controlled stopwatch connected to an ultraviolet light detector:
The electrolyte to be examined (500 μL) was applied to a Whatman GF/D (∅=24 mm) glass microfiber filter
The ignition source was transferred under the sample and held in this its position for a preset time (1, 5 or 10 seconds) to ignite the sample. Ignition and burning of the sample were detected using a UV light detector.
Evaluation is carried out by plotting the burning time/weight of electrolyte [s g⁻¹] over ignition time [s] and extrapolation by linear regression line to ignition time=0 s
Self-extinguishing time (s.g⁻¹) is the time that is needed until the sample stops burning once inflamed

| | Concentration (% wt) in standard electrolyte 1M LiPF₆ in (30% | | | | | |
|---|---|---|---|---|---|---|
| | Ethylene carbonate & 70% ethyl methyl carbonate) | | | | | |
| | 0 | 2 | 5 | 10 | 30 | 100 |
| Component | Self-extinguishing time (s · g⁻¹) | | | | | |
| 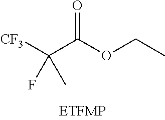 | 39 ± 2 | 30 ± 2 | 32 ± 2 | 30 ± 2 | 32 ± 2 | 30 ± 2 |

These measurements demonstrate that the compound ETFMP has flame retarding properties.

### Electrochemical Testing

### Drying

Before testing ETFMP was dried by treatment with a pre-activated type 4A molecular sieve. Water levels in the pre- and post-treated samples were determined by the Karl Fischer method:

| | Water level pre-treatment | Water level post-treatment |
|---|---|---|
| Compound | (ppm w/v) | (ppm w/v) |
| ETFMP | 623 | <10 |

### Electrolyte Formulation

Electrolyte preparation and storage was carried out in an argon filled glove box (both H₂O and O₂<0:1 ppm). The base electrolyte was 1 M LiPF₆ ethylene carbonate:ethyl methyl carbonate (30:70 wt. %) with ETFMP additive at concentrations of 2, 5, 10 and 30 wt. %.

### Cell Chemistry and Construction

The performance of each electrolyte formulation was tested in multi-layer pouch cells over 50 cycles (2 cells per electrolyte):

Chemistry 1: Lithium-Nickel-Cobalt-Manganese-Oxide (NCM622) positive electrode and artificial graphite (specific capacity: 350 mAh g⁻¹) negative electrode. The area capacity of NMC₆₂₂ and graphite amounted to 3,5 mAh cm⁻² and 4.0 mAh cm⁻², respectively. The N/P ratio amounted to 115%.

Chemistry 2: Lithium-Nickel-Cobalt-Manganese-Oxide (NCM622) positive electrode and SiOₓ/graphite (specific capacity: 550 mAh g⁻¹) negative electrode. The area capacity of NMC₆₂₂ and SiOₓ/graphite amount to 3.5 mAh/cm⁻² and 4.0 mAh cm⁻², respectively. The N/P ratio amounted to 115%.

The test pouch cells had the following characteristics:
Nominal capacity 240 mAh+/−2%
Standard deviations:

Capacity: ±0.6 mAh

Coulombic Efficiency (CE) 1^{st} cycle: ±0.13%

Coulombic Efficiency (CE) subsequent cycles: ±0.1%

Positive electrode: NMC-622
Active material content: 96.4%
Mass loading: 16.7 mg cm⁻²

Negative electrode: Artificial Graphite
Active material content: 94.8%
Mass loading: 10 mg cm⁻²
Separator: PE(16 pm)+4 μm Al₂O₃ Balanced at cut-off voltage of 4.2 V

Negative electrode: Artificial graphite+SiO
Active material content: 94.6%
Mass loading: 6.28 mg cm⁻²
Separator: PE(16 μm)+4 μm Al₂O₃
Balanced at cut-off voltage of 4.2 V

After assembly the following formation protocol was used:
1. Step charge to 1.5 V followed by 5 h rest step (wetting step 40° C.)
2. CCCV (C/1(J, 3.7 (Iₗᵢₘᵢₜ:1 h)) (preformation step)
3. Rest step (6 h)
4. CCCV (C/10, 4.2 V (Iₗᵢₘᵢₜ: 0.05 C)) rest step (20 min)
5. CC discharge (C/10, 3.8 V), (degassing of the cell)
6. CC discharge (C/10, 2.8 V)

Following this formation step, the cells were tested as follows:
Rest step (1.5 V, 5 h), CCCV (0/10, 3.7 V (1 h))
Rest step (6 h), CCCV (C/10, 4.2 V (Iₗᵢₘᵢₜ:0.05 C))
Rest step (20 min), CC discharge (C/10, 3.8 V)
Degassing step
Discharge (C/10, 2.8 V), rest step (5 h)
CCCV (0/3. 4.2 V (Iₗᵢₘᵢₜ:0.05 C)), rest step (20 min)
CC discharge (C/3, 2.8 V)
50 cycles or until 50% SOH is reached at 40° C.:

CCCV (C/3, 4.2 V (Iₗᵢₘᵢₜ:0.02 C)), rest step (20 min)

CC discharge (0/3, 3.0 V), rest step (20 min)

### Test Results

The test results for the additive ETF P in each cell chemistry are summarised in Tables 1-2 and FIGS. 1-2.

TABLE 1
Electrochemical performance of ETFMP - Cell Chemistry 1

| | | | Base electrolyte + | | Base electrolyte + | | Base electrolyte + | | Base electrolyte + | |
|---|---|---|---|---|---|---|---|---|---|---|
| | Base electrolyte | | 2 wt. % ETFMP | | 5 wt. % ETFMP | | 10 wt. % ETFMP | | 30 wt. % ETFMP | |
| | Discharge | Coulombic | Discharge | Coulombic | Discharge | Coulombic | Discharge | Coulombic | Discharge | Coulombic |
| Cycle | capacity | efficiency | capacity | efficiency | capacity | efficiency | capacity | efficiency | capacity | efficiency |
| No. | (mAh) | (%) | (mAh) | (%) | (mAh) | (%) | (mAh) | (%) | (mAh) | (%) |
| 1^{st} (0.1 C) | 232.2 | 90.61 | 235.5 | 88.93 | 234.1 | 88.19 | 231.7 | 87.70 | 233.8 | 87.64 |
| 3^{rd} (0.3 C) | 224.4 | 99.55 | 230.7 | 99.52 | 228.8 | 99.49 | 226.9 | 99.48 | 229.4 | 99.45 |
| 50^{th} (0.3 C) | 218.1 | 99.83 | 223.4 | 99.75 | 221.4 | 99.76 | 219.5 | 99.86 | 221.9 | 99.89 |

TABLE 2
Electrochemical performance of ETFMP - Cell Chemistry 2

| | | | Base electrolyte + | | Base electrolyte + | | Base electrolyte + | | Base electrolyte + | |
|---|---|---|---|---|---|---|---|---|---|---|
| | Base electrolyte | | 2 wt. % ETFMP | | 5 wt. % ETFMP | | 10 wt. % ETFMP | | 30 wt. % ETFMP | |
| | Discharge | Coulombic | Discharge | Coulombic | Discharge | Coulombic | Discharge | Coulombic | Discharge | Coulombic |
| Cycle | capacity | efficiency | capacity | efficiency | capacity | efficiency | capacity | efficiency | capacity | efficiency |
| No. | (mAh) | (%) | (mAh) | (%) | (mAh) | (%) | (mAh) | (%) | (mAh) | (%) |
| 1^{st} (0.1 C) | 199.6 | 74.52 | 192.5 | 71.76 | 192.8 | 72.23 | 195.2 | 72.67 | 193.8 | 72.40 |
| 3^{rd} (0.3 C) | 176.3 | 97.03 | 174.2 | 97.06 | 173.0 | 97.19 | 174.6 | 97.15 | 173.7 | 97.29 |
| 50^{th} (0.3 C) | 125.7 | 99.62 | 126.3 | 99.52 | 126.7 | 99.52 | 130.1 | 99.63 | 130.2 | 99.62 |

From this data it can be seen that the additive in both cell chemistries had a positive influence on cell performance improving both Coulombic efficiency and cycling stability. These results combined with the safety related studies demonstrate that the compounds of this invention simultaneously improved both the safety and performance of energy storage devices containing them.

### FIGURES

FIGS. 1-2 show the test results for the addi lye ETFMP in each cell chemistry.

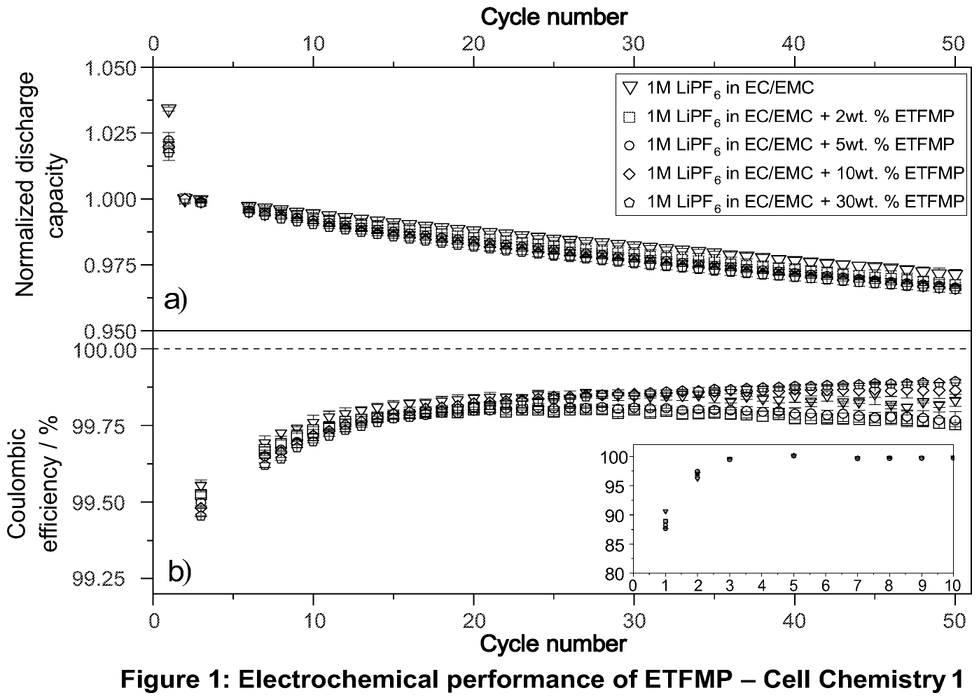

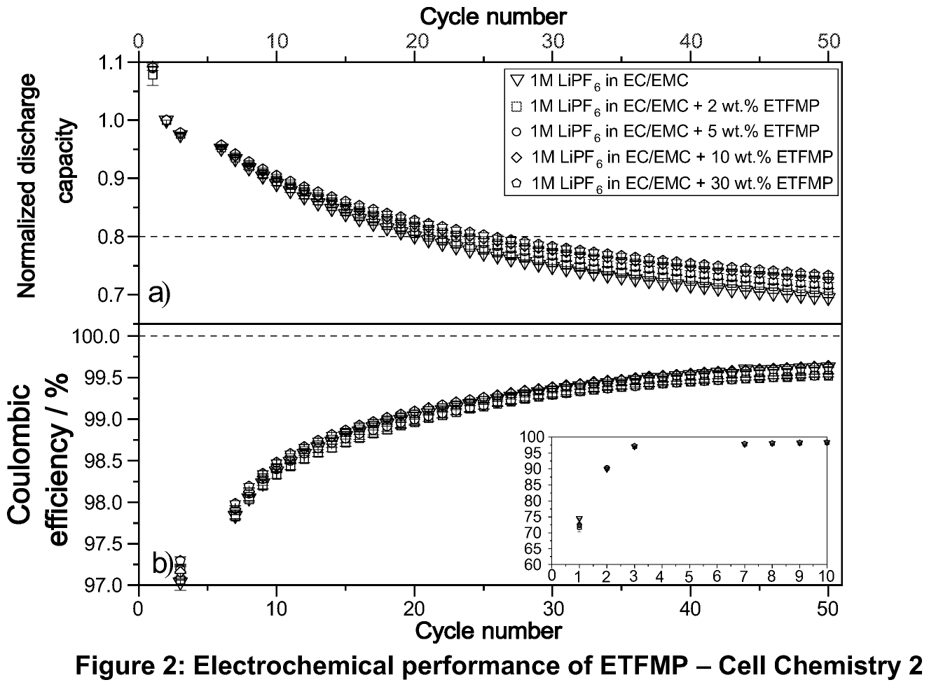

1. A nonaqueous battery electrolyte formulation, comprising a compound of Formula (I): 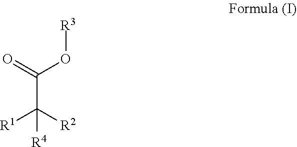
wherein R¹ is selected from the group consisting of CF₃, CH₂CF₃, and CFHCF₃;
R² is selected from the group consisting of H, F, CH₃, CH₂F, CH₂CF₃, CH₂OR⁵, and OR⁵;
R³ is an alkyl group, with the a formula CₙH₂ₙ₊₁₋ₓFₓ;
R⁴ is H or F; and
R⁵ is aft a second alkyl groups ₛubstituted with at least one fluorine substituent,
provided that when R¹ is CH₂CF₃ or CFHCF₃, R² is H, F, or OR⁵; and wherein the compound of Formula (I) is present in the electrolyte formulation in an amount of 95 wt. % or less.

2. A battery, comprising the formulation according to claim 1.

3. The formulation according to claim 1, further comprising a metal electrolyte salt, present in an amount of from 0.1 to 20 wt. % relative to a total mass of the formulations wherein the metal salt is a salt of lithium, sodium, magnesium, calcium, lead, zinc, or nickel.

4. (canceled)

5. The formulation according to claim 3, wherein the metal salt is a salt of lithium selected from the group consisting of lithium hexafluorophosphate (LiPF₆), lithium hexafluoroarsenate monohydrate (LiAsF₆·H₂O), lithium perchlorate (LiC₁O₄), lithium tetrafluoroborate (LiBF₄), lithium triflate (LiSO₂CF₃), lithium bis(fluorosulfonyl)imide (Li(FSO₂)₂N), and lithium bis(trifluoromethanesulfonyl)imide (Li(CF₃SO₂)₂N).

6. The formulation according to claim 1, wherein the formulation comprises further comprising an additional solvent in an amount of from 0.1 wt. % to 99.9 wt. % of a liquid component of the formulation, wherein the additional solvent is selected from the group consisting of dimethyl carbonate (DMC), ethyl methyl carbonate (EMC), fluoroethylene carbonate (FEC), propylene carbonate (PC), and ethylene carbonate (EC).

7-8. (canceled)

9. A The formulation according to claim 1, further comprising a metal ion, optionally in combination with a solvent.

10-15. (canceled)

16. A method of reducing the flammability of a battery and/or a battery electrolyte, the method comprising adding to the battery and/or the battery electrolyte the formulation according to claim 1.

17. A method of powering an article comprising a battery, the method comprising a adding to the battery a battery electrolyte formulation comprising a compound of Formula (I): 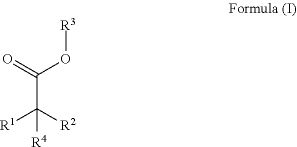
wherein R¹ is selected from the group consisting of CF₃, CH₂CF₃, and CFHCF₃;
R² is selected from the group consisting of H, F, CH₃, CH₂F, CH₂CF₃, CH₂OR⁵, and OR⁵;
R³ is an alkyl group, with a formula CₙH₂ₙ₊₁₋ₓFₓ;
R⁴ is H or F; and
R⁵ is a second alkyl groups substituted with at least one fluorine substituent,
provided that when R¹ is CH₂CF₃ or CFHCF₃, R² is H, F, or OR⁵; and wherein the compound of Formula (I) is present in the electrolyte formulation in an amount of 95 wt. % or less.

18. A method of retrofitting a battery electrolyte formulations the method comprising (a) at least partially replacing the battery electrolyte with the formulation according to claim 1; and/or (b) supplementing the battery electrolyte with the formulation.

19. A method of preparing the formulation according to claim 5, the method comprising mixing the compound of Formula (I) with dimethyl carbonate (DMC), ethyl methyl carbonate (EMC), fluoroethylene carbonate (FEC), propylene carbonate (PC), or ethylene carbonate (EC) and with the salt of lithium so as to produce the formulation.

20. The method according to claim 17, wherein a capacity of the battery and/or a charge transfer within the battery is improved relative to a battery without the formulation.

21. The method according to claim 17, wherein the formulation comprises a metal electrolyte salt, present in an amount of from 0.1 to 20 wt. % relative to a total mass of the formulations wherein the metal electrolyte salt is a salt of lithium, sodium, magnesium, calcium, lead, zinc, or nickel.

22. (canceled)

23. The method according to claim 21, wherein the metal salt is a salt of lithium selected from the group consisting of lithium hexafluorophosphate (LiPF₆), lithium hexafluoroarsenate monohydrate (LiAsF₆·H₂O), lithium perchlorate (LiClO₄), lithium tetrafluoroborate (LiBF₄), lithium triflate (LiSO₂CF₃), lithium bis(fluorosulfonyl)imide (Li(FSO₂)₂N), and lithium bis(trifluoromethanesuflonyl)imide (Li(CF₃SO₂)₂N).

24. The method according to claim 17, wherein the formulation comprises an additional solvent in an amount of from 0.1 wt. % to 99.9 wt. % of a liquid component of the formulation, wherein the additional solvent is selected from the group consisting of dimethyl carbonate (DMC), ethyl methyl carbonate (EMC), fluoroethylene carbonate (FEC), propylene carbonate (PC), and ethylene carbonate (EC).

25-27. (canceled)

28. A nonaqueous battery electrolyte formulation, comprising a compound of Formula (I): 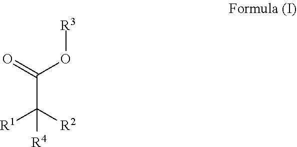
wherein R¹ is selected from the group consisting of CF₃, CH₂CF₃, and CFHCF₃;
R² is selected from the group consisting of H, F, CH₃, CH₂F, CH₂CF₃, CH₂OR⁵, and OR⁵;
R³ is an alkyl group, with a formula CₙH₂ₙ₊₁₋ₓFₓ;
R⁴ is H or F; and
R⁵ is a second alkyl group substituted with at least one fluorine substituent;
wherein the compound of Formula (I) is present in the formulation in an amount of 95 wt. % or less; and
provided that when R¹ is CH₂CF₃ or CFHCF₃, R² is H, F, or OR⁵; and
further provided that when the compound of Formula I is a compound of Formula (Ia) or a compound of Formula (Ib) 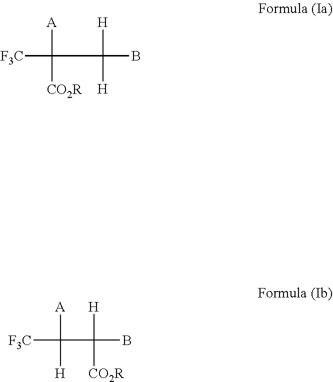
each of A and B is not H, CH₃, F, Cl, CH₂F, CF₃, OCF₃, OCH₂CF₃, OCH₂CF₂CHF₂, or CH₂CF₃; and
R is not OCₙH₂ₙ₊₁₋ₓFₓ or CₙH₂ₙ₊₁₋ₓFₓ.

29. A battery, comprising the formulation according to claim 28.

30. The formulation according to claim 28, further comprising a metal electrolyte salt, present in an amount of from 0.1 to 20 wt. % relative to a total mass of the formulation, wherein the metal salt is a salt of lithium, sodium, magnesium, calcium, lead, zinc, or nickel.

31. The formulation according to claim 30, wherein the metal salt is a salt of lithium selected from the group consisting of lithium hexafluorophosphate (LiPF₆), lithium hexafluoroarsenate monohydrate (LiAsF₆ H₂O), lithium perchlorate (LiClO₄), lithium tetrafluoroborate (LiBF₄), lithium triflate (LiSO₂CF₃), lithium bis(fluorosulfonyl)imide (Li(FSO₂)₂N), and lithium bis(trifluoromethanesulfonyl)imide (Li(CF₃SO₂)₂N).

32. The formulation according to claim 28, further comprising an additional solvent in an amount of from 0.1 wt. % to 99.9 wt. % of a liquid component of the formulation, wherein the additional solvent is selected from the group consisting of dimethyl carbonate (DMC), ethyl methyl carbonate (EMC), fluoroethylene carbonate (FEC), propylene carbonate (PC), and ethylene carbonate (EC).

33. A method of powering an article comprising a battery, the method comprising adding to the battery the formulation according to claim 28.
